(19) United States
(12) Patent Application Publication
(10) Pub. No.: US 2021/0155053 A1
(43) Pub. Date: May 27, 2021

(54) PNEUMATIC TIRE

(71) Applicant: The Yokohama Rubber Co., LTD., Tokyo (JP)

(72) Inventor: Ryouichi TOMOMATSU, Kanagawa (JP)

(21) Appl. No.: 17/257,142

(22) PCT Filed: Jul. 1, 2019
(86) PCT No.: PCT/JP2019/026182

§ 371 Date: Dec. 30, 2020

(30) Foreign Application Priority Data
Jul. 2, 2018 (JP) 2018-126060

(51) Int. Cl. B60C 11/13; B60C 11/03; B60C 11/12

(52) U.S. Cl. CPC B60C 11/1307; B60C 11/0304; B60C 2011/0346; B60C 11/1236; B60C 11/0302; B60C 11/1204

(57) ABSTRACT

In a pneumatic tire, a circumferential main groove having a zigzag shape and extending in a tire circumferential direction in a contact patch of a tread portion, and land portions defined and formed on both sides in a tire width direction of the circumferential main groove, with the circumferential main groove as a boundary, are provided. A contact patch of each of the land portions is formed protruding from a reference profile toward an outer side in a tire radial direction.

### TECHNICAL FIELD

The present technology relates to a pneumatic tire.

### BACKGROUND ART

It is considered that in order to improve the steering stability on dry road surfaces, the land portion width of a tread portion should be set wide, with the aim of ensuring the tread rigidity. However, in this case, the contact patch pressure at the center of the land portion in a width direction is lowered and a contact patch length of the land portion in a tire circumferential direction is shortened in a ground contact region, so the end portions of the contact patch length collapse inward and the footprint properties worsen. As a result, steering stability performance on dry road surfaces may be compromised. Furthermore, a lower contact patch pressure at the center in the width direction of the land portion might result in poor drainage performance, and thus steering stability performance on wet road surfaces may also be compromised.

Japan Unexamined Patent Publication Nos. 2013-189121, 2016-002890 and 2014-118123 disclose examples of conventional solutions for improving the steering stability performance on dry road surfaces and steering stability performance on wet road surfaces. The solutions rely on a configuration in which the center of the contact patch of the land portion in the width direction protrudes. Furthermore, Japan Unexamined Patent Publication No. 2017-030556 discloses an example where both steering stability performance on dry road surfaces and steering stability performance on wet road surfaces are achieved in a highly balanced manner, with a center main groove having a zigzag shape and a lug groove formed in the land portion adjacent to the center main groove being terminated within the land portion so that the land portion is guaranteed to be sufficiently rigid.

Nevertheless, due to recent improvements in vehicle performance, an even higher level of improvement has been required for the steering stability performance on dry road surfaces and the steering stability performance on wet road surfaces. In particular, it has been found that a main groove with a zigzag shape would lead to non-uniform contact patch pressure around the groove edge, resulting in a shortened contact patch length in the tire circumferential direction of the land portion adjacent to the main groove in the tire width direction, which would affect the steering stability performance on dry road surfaces and the steering stability performance on wet road surfaces. In this context, further improvement in the steering stability performance on dry road surfaces and the steering stability performance on wet road surfaces has been called for.

### SUMMARY

The present technology provides a pneumatic tire that can improve the steering stability performance on dry road surfaces and the steering stability performance on wet road surfaces.

A pneumatic tire according to one aspect of the present technology includes: a circumferential main groove having a zigzag shape and extending in a tire circumferential direction in a contact patch of a tread portion; and land portions defined and formed on both sides in a tire width direction of the circumferential main groove, with the circumferential main groove as a boundary. A contact patch of each of the land portions is formed protruding from a reference profile toward an outer side in a tire radial direction.

Furthermore, in the pneumatic tire according to one aspect of the present technology, protruding amounts Ha and Hb of the respective land portions are preferably in ranges of 0.2 mm≤Ha≤0.4 mm and 0.2 mm≤Hb≤0.4 mm.

Furthermore, in the pneumatic tire according to one aspect of the present technology, the protruding amounts Ha and Hb of the respective land portions preferably satisfy a relationship 0.9≤Ha/Hb≤1.1.

Furthermore, in the pneumatic tire according to one aspect of the present technology, the pneumatic tire preferably includes: shoulder land portions defined and formed on outer most sides in the tire width direction in the contact patch of the tread portion; and a plurality of lug grooves that are disposed side by side in the tire circumferential direction and extend intersecting the tire circumferential direction in the contact patch of the shoulder land portions, the plurality of lug grooves defining a plurality the shoulder land portions in the tire circumferential direction. A number of bent portions in the tire circumferential direction forming the zigzag shape of the circumferential main groove is preferably n or n/2, where n represents a number of the shoulder land portions defined by the lug grooves in the tire circumferential direction.

Furthermore, in the pneumatic tire according to one aspect of the present technology, the circumferential main groove is preferably disposed in a range that is 30% of a ground contact width centered on the tire equatorial plane.

Furthermore, in the pneumatic tire according to one aspect of the present technology, the circumferential main groove preferably includes a plurality of triangular chamfered portions, with which the zigzag shape opens to the contact patch in a groove opening end, formed side by side in the tire circumferential direction.

Furthermore, in the pneumatic tire according to one aspect of the present technology, the chamfered portions of the circumferential main groove preferably have a tire width direction dimension Wg in a range of 1.0 mm≤Wg≤3.5 mm, and have a tire radial direction dimension Lg in a range of 1.0 mm≤Lg≤3.0 mm.

Furthermore, in the pneumatic tire according to one aspect of the present technology, land portion widths Wa and Wb of the respective land portions on both sides in the tire width direction bounded by the circumferential main groove preferably satisfy a relationship 0.8≤Wa/Wb≤1.5.

With the present technology, the contact patches of the land portions provided on both sides in the tire width direction and bounded by the circumferential main groove having a zigzag shape are formed to protrude toward the outer side in the tire radial direction from the reference profile, thus, the contact patch length in the center portion of each land portion in the tire width direction can be ensured, whereby the contact patch pressure of each land portion can be ensured. Thus, non-uniformity of the contact patch pressure around the groove edge of the circumferential main groove having a zigzag shape is suppressed, whereby a ground contact effect can be improved so that the steering stability performance on dry road surfaces can be improved. Furthermore, with non-uniformity of the contact patch pressure around the groove edge of the circumferential main groove having a zigzag shape suppressed, a water removing effect for the circumferential main groove is improved, whereby the steering stability performance on wet road surfaces can be improved. As a result, the steering stability performance on dry road surfaces and the steering stability performance on wet road surfaces can be improved.

### BRIEF DESCRIPTION OF DRAWINGS

FIG. 1 is a meridian cross-sectional view of a pneumatic tire according to an embodiment of the present technology.

FIG. 2 is a plan view of a tread portion of the pneumatic tire according to the embodiment of the present technology.

FIG. 3 is a detailed view of the tread portion of FIG. 1.

FIG. 4 is a detailed view of the tread portion of FIG. 2.

FIG. 5 is a detailed perspective view of the tread portion.

FIG. 6 is a plan view of the tread portion of another example of the pneumatic tire according to the embodiment of the present technology.

FIGS. 7A-7D include a table showing results of performance evaluation tests of pneumatic tires according to examples of the present technology.

### DETAILED DESCRIPTION

Embodiments of the present technology are described in detail below with reference to the drawings. However, the present technology is not limited by the embodiment. Furthermore, constituents of the embodiment include elements that are essentially identical or that can be substituted or easily conceived by one skilled in the art. Furthermore, the plurality of modified examples described in the embodiment can be combined as desired within the scope apparent to one skilled in the art.

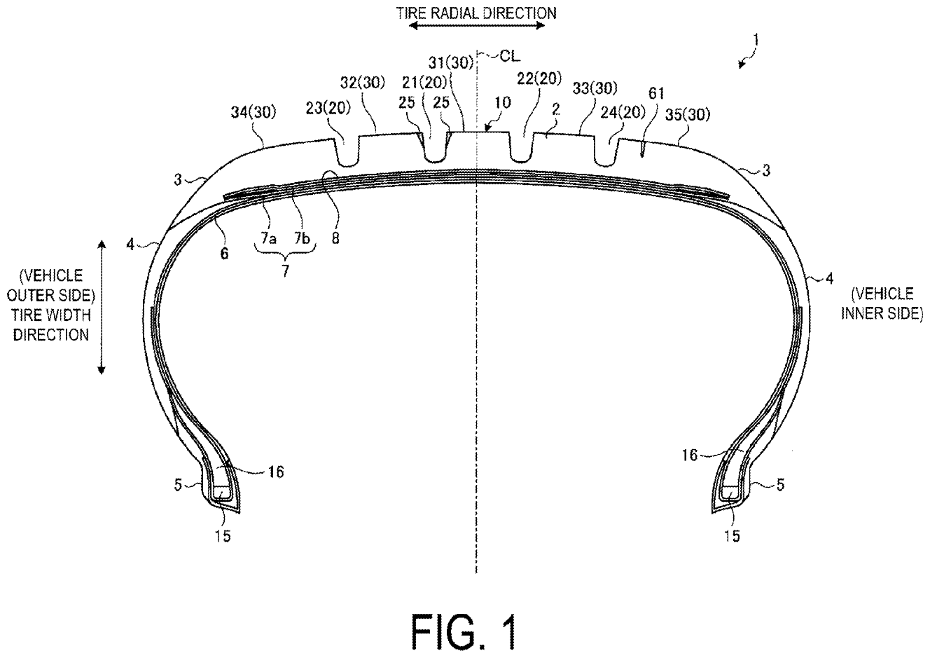

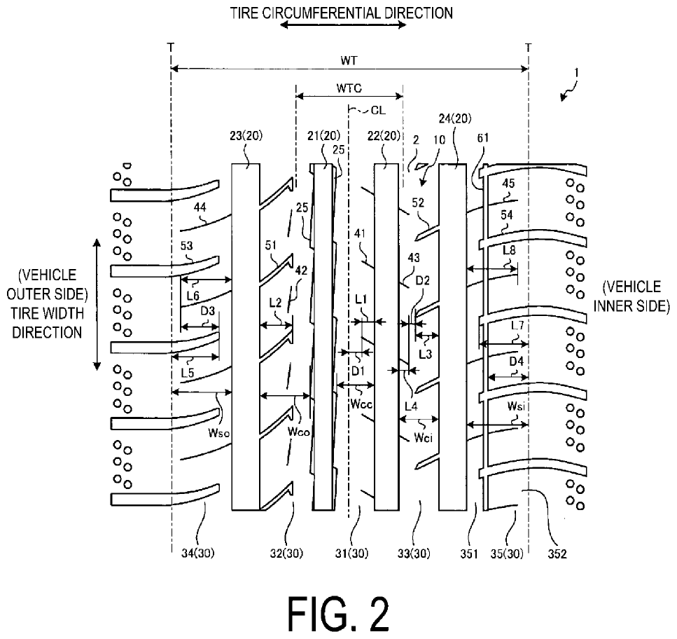

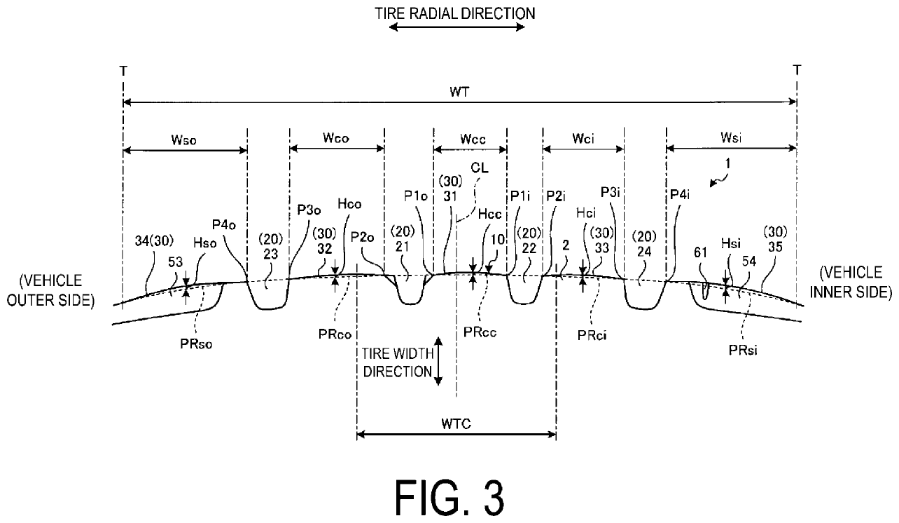

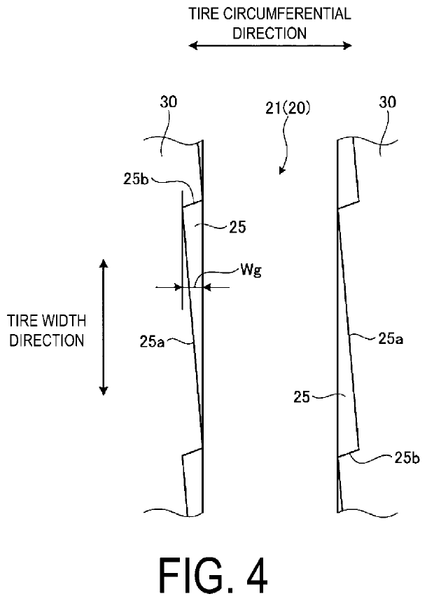

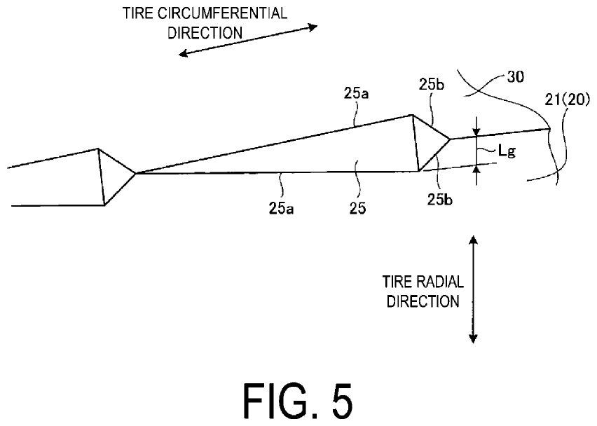

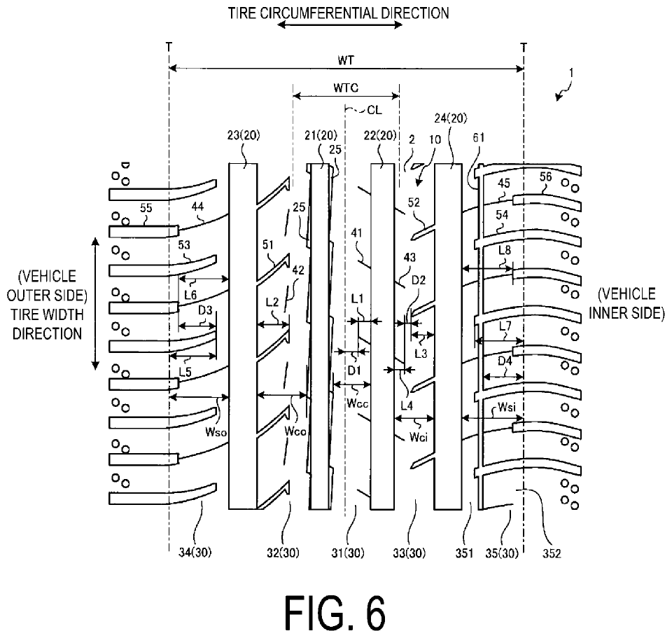

FIG. 1 is a meridian cross-sectional view of a pneumatic tire according to the present embodiment. FIG. 2 is a plan view of a tread portion of the pneumatic tire according to the present embodiment. FIG. 3 is a detailed view of the tread portion of FIG. 1. FIG. 4 is a detailed view of the tread portion of FIG. 2. FIG. 5 is a detailed perspective view of the tread portion. FIG. 6 is a plan view of the tread portion of another example of the pneumatic tire according to the present embodiment.

In the following description, the tire radial direction refers to a direction orthogonal to the rotation axis (not illustrated) of a pneumatic tire 1, the inner side in the tire radial direction refers to the side facing the rotation axis in the tire radial direction, and the outer side in the tire radial direction refers to the side away from the rotation axis in the tire radial direction. Moreover, the tire circumferential direction refers to the circumferential direction with the rotation axis as the central axis. Additionally, the tire width direction refers to a direction parallel with the rotation axis, the inner side in the tire width direction refers to a side toward the tire equatorial plane (tire equator line) CL in the tire width direction, and the outer side in the tire width direction refers to a side away from the tire equatorial plane CL in the tire width direction. The tire equatorial plane CL is a plane that is orthogonal to the rotation axis of the pneumatic tire 1 and passes through the center of the tire width of the pneumatic tire 1, and in the tire equatorial plane CL, the center line in the tire width direction, which is the center position of the pneumatic tire 1 in the tire width direction, coincides with the position in the tire width direction. The tire equator line is a line that is on the tire equatorial plane CL and is along the tire circumferential direction of the pneumatic tire 1, and is denoted with the reference sign “CL” that denotes the tire equatorial plane in the present embodiment.

As illustrated in FIG. 1, the pneumatic tire 1 of the present embodiment includes a tread portion 2, shoulder portions 3 on opposite sides of the tread portion 2, and sidewall portions 4 and bead portions 5 continuing on from the shoulder portions 3 in that order. Additionally, the pneumatic tire 1 includes a carcass layer 6, a belt layer 7, and a belt reinforcing layer 8.

The tread portion 2 is made of a rubber material (tread rubber) and is exposed on the outermost side of the pneumatic tire 1 in the tire radial direction, with the outer circumferential surface thereof constituting the contour of the pneumatic tire 1. The outer circumferential surface of the tread portion 2 is a surface that may come into contact with the road surface while the vehicle is traveling, and is configured as a contact patch 10.

The shoulder portions 3 are portions of the tread portion 2 located on both outer sides in the tire width direction. Additionally, the sidewall portions 4 are exposed on the outermost sides of the pneumatic tire 1 in the tire width direction. Additionally, the bead portions 5 each include a bead core 15 and a bead filler 16. The bead core 15 is formed by winding a bead wire, which is a steel wire, into a ring shape. The bead filler 16 is a rubber material that is disposed in the space formed by an end portion of the carcass layer 6 in the tire width direction being folded back at the position of the bead core 15.

The end portions of the carcass layer 6 in the tire width direction are folded back around the pair of bead cores 15 from the inner side in the tire width direction to the outer side in the tire width direction, and the carcass layer 6 is stretched in a toroidal shape in the tire circumferential direction to form the framework of the tire. The carcass layer 6 is made of a plurality of coating rubber-covered carcass cords (not illustrated) disposed side by side with an angle with respect to the tire circumferential direction along the tire meridian direction at an angle with respect to the tire circumferential direction. The carcass cords are made of organic fibers such as polyester, rayon, nylon, and the like, for example. The carcass layer 6 is provided with at least one layer.

The belt layer 7 has a multilayer structure in which at least two belts 7a, 7b are layered, in the tread portion 2, the outer circumference of the carcass layer 6 is arranged on the outer side in the tire radial direction, and the carcass layer 6 is covered in the tire circumferential direction. The belts 7a and 7b are formed by coating a plurality of cords (not illustrated) that are disposed side by side at a predetermined angle (for example, 20° to 30°) with respect to the tire circumferential direction with a rubber coating. The cord is made, for example, of steel or an organic fiber such as polyester, rayon, nylon or the like. Additionally, the overlapping belts 7a and 7b are arranged so that the cords intersect with each other.

The belt reinforcing layer 8 is disposed on the outer side of the belt layer 7 in the tire radial direction, i.e. on the outer circumference thereof, and covers the belt layer 7 in the tire circumferential direction. The belt reinforcing layer 8 is formed by a plurality of rubber-coated cords (not illustrated) disposed substantially parallel to the tire circumferential direction and disposed side by side in the tire width direction. The cord is made of steel or an organic fiber such as polyester, rayon, nylon, or the like, and the cord angle is within a range of ±5° with respect to the tire circumferential direction for example. The belt reinforcing layer 8 illustrated in FIG. 1 is disposed so as to cover the entire belt layer 7. The configuration of the belt reinforcing layer 8 is not limited to that described above. Although not illustrated in the drawings, a configuration may be used in which the belt reinforcing layer 8 is disposed so as to cover only the end portions of the belt layer 7 in the tire width direction. Alternatively, for example, a configuration with two reinforcing layers may be used, in which the inner reinforcing layer in the tire radial direction is formed larger than the belt layer 7 in the tire width direction so as to cover the entire belt layer 7, and the outer reinforcing layer in the tire radial direction is disposed so as to only cover the end portions of the belt layer 7 in the tire width direction. In another example, a configuration with two reinforcing layers may be used, in which both of the reinforcing layers are disposed so as to only cover the end portions of the belt layer 7 in the tire width direction. In other words, the belt reinforcing layer 8 overlaps with at least the end portion of the belt layer 7 in the tire width direction. Additionally, the belt reinforcing layer 8 is configured by winding a band-like strip material, having a width of about 10 mm, for example, in the tire circumferential direction.

Note that the internal structure of the pneumatic tire 1 described above represents a typical example for a pneumatic tire 1, and the internal structure is not limited thereto.

The pneumatic tire 1 according to the present embodiment has a specified mounting direction with respect to the vehicle. In other words, when the pneumatic tire 1 of the present embodiment is mounted on the vehicle, the orientation with respect to the outer side and the inner side of the vehicle in the tire width direction is designated. The orientation designations, while not illustrated in the drawings, for example, can be shown via indicators provided on the sidewall portions 4. Therefore, the side facing the outer side of the vehicle is the “vehicle outer side” and the side facing the inner side of the vehicle when mounted on the vehicle is the vehicle inner side”. Note that the designations of the vehicle outer side and the vehicle inner side are not limited to cases when mounted on the vehicle. For example, in cases when the tire is mounted on a rim, orientation of the rim with respect to the outer side and the inner side of the vehicle in the tire width direction is predetermined. Thus, in cases in which the pneumatic tire 1 is mounted on a rim, the orientation with respect to the vehicle outer side and the vehicle inner side in the tire width direction is designated.

The contact patch 10 of the tread portion 2 includes four circumferential main grooves 20 that are formed side by side in the tire width direction, extend in the tire circumferential direction, and are continuous over the entire circumference of the tire.

The circumferential main groove 20 refers to a groove on which a wear indicator must be provided as specified by JATMA (The Japan Automobile Tyre Manufacturers Association, Inc.) and has a groove width of 3.0 mm or greater and a groove depth of 6.0 mm or greater.

Note that a groove width, a sipe width, and a land portion width in the following description are measured as the maximum value of the dimension in the tire width direction of both groove opening ends that open to the contact patch 10, with the pneumatic tire 1 mounted on a specified rim, inflated to the specified internal pressure, and in an unloaded state (specified load=0). In a configuration in which a notch portion and a chamfered portion 25 are formed in a groove opening edge, the groove width including the notch portion and the chamfered portion 25, with the groove opening end serving as the outer edges of the notch portion and the chamfered portion 25, is measured. A groove depth and a sipe depth are measured as the maximum value of the dimension from the contact patch 10 to the groove bottom, with the pneumatic tire 1 mounted on a specified rim, inflated to the specified internal pressure, and in an unloaded state (specified load=0).

Here, “specified rim” refers to a “standard rim” defined by the Japan Automobile Tyre Manufacturers Association Inc. (JATMA), a “design rim” defined by the Tire and Rim Association, Inc. (TRA), or a “measuring rim” defined by the European Tyre and Rim Technical Organization (ETRTO). Moreover, the specified internal pressure refers to a “maximum air pressure” defined by JATMA, the maximum value in “TIRE LOAD LIMITS AT VARIOUS COLD INFLATION PRESSURES” defined by TRA, or “INFLATION PRESSURES” defined by ETRTO. Moreover, “Specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

Two circumferential main grooves 20 are disposed on each of outer sides of the tire equatorial plane Cl in the tire width direction. One of the circumferential main grooves 20 on the vehicle outer side that is closer the tire equatorial plane CL is referred to as an outer side center main groove (may also be referred to as a center main groove) 21, and the circumferential main groove 20 on the outer side of the outer side center main groove 21 in the tire width direction is referred to as an outer side shoulder main groove (may also be referred to as a shoulder main groove) 23. One of the circumferential main grooves 20 on the vehicle inner side that is closer the tire equatorial plane CL is referred to as an inner side center main groove (may also be referred to as a center main groove) 22, and the circumferential main groove 20 on the outer side of the inner side center main groove 22 in the tire width direction is referred to as an inner side shoulder main groove (may also be referred to as a shoulder main groove) 24.

In the present embodiment, the outer side center main groove 21 of the circumferential main grooves 20 is formed in a zigzag shape that bends at a predetermined interval toward both sides in the tire width direction while extending along the tire circumferential direction. The other grooves (the inner side center main groove 22, the outer side shoulder main groove 23, and inner side shoulder main groove 24) are formed linearly along the tire circumferential direction. As illustrated in FIGS. 4 and 5, the outer side center main groove 21 is formed in the zigzag shape, with its groove opening ends being provided with the chamfered portions 25 that have a triangular shape, include a long portion 25a and a short portion 25b in the contact patch 10, and are formed side by side in the tire circumferential direction, and with the long portion 25a and the short portion 25b of the chamfered portion 25 being arranged point symmetrically on both groove opening ends. Although not elaborated in the figures, the outer side center main groove 21 itself may be formed in the zigzag shape, with its groove walls being provided with triangular recesses including the long portion 25a and the short portion 25b in plan view and formed side by side in the tire circumferential direction while being in communication with the contact patch 10 and the groove bottom, and with the long portion 25a and the short portion 25b of the recesses being arranged point symmetrically on both groove walls.

Additionally, five land portions 30 arranged in the tire width direction are defined and formed by four circumferential main grooves 20 (21, 22, 23, 24) in the contact patch 10 of the tread portion 2. The land portion 30 on the tire equatorial plane Cl formed between the outer side center main groove 21 and the inner side center main groove 22 is referred to as a center land portion 31. On the vehicle outer side, the land portion 30 formed between the outer side center main groove 21 and the outer side shoulder main groove 23 is referred to as an outer side middle land portion (may also be referred to as a middle land portion) 32, and the land portion 30 formed on the outer side of the outer side shoulder main groove 23 in the tire width direction is referred to as an outer side shoulder land portion (may also be referred to as a shoulder land portion) 34. On the vehicle inner side, the land portion 30 formed between the inner side center main groove 22 and the inner side shoulder main groove 24 is referred to as an inner side middle land portion (may also be referred to as a middle land portion) 33, and the land portion 30 formed on the outer side of the inner side shoulder main groove 24 in the tire width direction is referred to as an inner side shoulder land portion (may also be referred to as a shoulder land portion) 35. The outer side shoulder main groove 23 and the inner side shoulder main groove 24 are each located on a ground contact edge T.

The ground contact edges T are both outermost ends of the ground contact region in the tire width direction, and are continuous in the tire circumferential direction in FIG. 2. The ground contact region is the region where the contact patch 10 of the tread portion 2 of the pneumatic tire 1 comes into contact with a dry, flat road surface, when the pneumatic tire 1 is mounted on a specified rim, inflated to the specified internal pressure, and loaded with 70% of the specified load.

The center land portion 31 only has a sipe 41 formed on the contact patch 10. The sipe 41 is provided extending toward the tire equatorial plane CL (inner side in the tire width direction) with one end in communication with the inner side center main groove 22 and with the other end terminated inside the contact patch 10 of the center land portion 31. A plurality of the sipes 41 are provided at an interval along the tire circumferential direction. The sipe 41 has a sipe width in a range between 0.6 mm and 1.8 mm both inclusive, and a sipe depth in a range between 3.0 mm and 7.0 mm both inclusive. The sipes 41 are closed when the contact patch 10 is in contact with the ground. The sipes 41 ensure tread rigidity to contribute to improvement of the steering stability performance on dry road surfaces compared with a configuration in which a plurality of lug grooves are arranged along the tire circumferential direction in the center land portion 31. Additionally, the inclination angle of the sipe 41 with respect to the tire circumferential direction is in a range between 45 deg and 80 deg both inclusive. The sipe 41 has the inclination angle ensured to be 45 deg or greater to contribute to suppression of chipping wear, and has the inclination angle ensured to be 80 deg or less to contribute to the steering stability performance on wet road surfaces with an edge effect.

The sipe 41 preferably satisfies a relationship 0.30≤L1/Wcc≤0.60, where L1 represents a dimension of the sipe 41 in the tire width direction and Wcc represents the land portion width of the center land portion 31. The land portion width Wcc of the center land portion 31 is the dimension in the tire width direction of the contact patch 10 excluding the chamfered portion 25 of the circumferential main groove 20, and may be also referred to as a ground contact width of actual contact with the road surface. The land portion width of the other land portions is similarly defined in the following description. The sipes 41 satisfies 0.30≤L1/Wcc to ensure a water removing effect to contribute to the improvement of the steering stability performance on wet road surfaces, and satisfies L1/Wcc≤0.60 to ensure the rigidity of the center land portion 31 to contribute to steering stability performance on dry road surfaces.

The outer side middle land portion 32 only has a lug groove 51 and a sipe 42 formed on the contact patch 10.

The lug groove 51 is provided extending toward the inner side in the tire width direction with one end in communication with the outer side shoulder main groove 23 and with the other end terminated inside the contact patch 10 of the outer side middle land portion 32. The lug groove 51 is formed mainly extending in the tire width direction in a long form and including a bent portion at the other end to mainly extend in the tire circumferential direction in a short form. A plurality of the lug grooves 51 are provided at an interval along the tire circumferential direction. The lug groove 51 has a sipe (not illustrated) along the longitudinal direction of the groove bottom and has a chamfered portion on the contact patch 10 side of the sipe, to be formed in the configuration described above. The chamfer portion may be on both sides of the sipe width of the sipe or only on one side of the sipe width. The sipe of the lug groove 51 has a sipe width in a range between 0.3 mm and 1.5 mm both inclusive, and a sipe depth from the contact patch 10 in a range between 3.3 mm and 4.5 mm both inclusive. The lug groove 51 has a depth of the chamfered portion in the sipe depth, being in a range between 1.0 mm and 3.0 mm both inclusive, and a chamfered width in a range between 1.5 mm and 4.5 mm both inclusive. The lug groove 51 only has the sipe closed when the contact patch 10 comes into contact with the road surface.

The lug groove 51 preferably satisfies a relationship 0.65≤L2/Wco≤0.85, where L2 represents a dimension of the lug groove 51 in the tire width direction and Wco represents the land portion width of the outer side middle land portion 32. The lug groove 51 satisfies 0.65≤L2/Wco to ensure a water removing effect to contribute to the improvement of the steering stability performance on wet road surfaces, and satisfies L2/Wco≤0.85 to ensure the rigidity of the outer side middle land portion 32 to contribute to steering stability performance on dry road surfaces. In particular, the lug groove 51 is disposed in an edge portion on the outer side in the tire width direction (the ground contact edge T side), which contributes to the contribution of the water removing effect in the outer side middle land portion 32, and thus largely contributes to improvement of steering stability performance on wet road surfaces.

The sipes 42 are each independently disposed between the terminating end portions of the lug grooves 51 adjacent to each other in the tire circumferential direction, and mainly extend in the tire circumferential direction. The sipe 42 is not in communication with the lug grooves 51 or the circumferential main groove 20, and has both ends terminating within the contact patch 10 of the outer side middle land portion 32. The sipe 42 extends in parallel to the long portion 25a of the chamfered portion 25 of the outer side center main groove 21. The sipe 42 has a sipe width in a range between 0.6 mm and 1.8 mm both inclusive, and a sipe depth in a range between 3.0 mm and 7.0 mm both inclusive. The sipe 42 is closed when the contact patch 10 is in contact with the ground. The sipe 42 is arranged between the terminating end portions of the lug grooves 51 having the dimension L2 in the tire width direction as described above, and thus is in appropriate arrangement relationship with the lug grooves 51 and the circumferential main groove 20 to achieve uniform rigidity of the outer side middle land portion 32, to thus contribute to the steering stability performance on dry road surfaces.

The inner side middle land portion 33 only has a lug groove 52 and a sipe 43 formed on the contact patch 10.

The lug groove 52 is provided extending toward the inner side in the tire width direction with one end in communication with the inner side shoulder main groove 24 and with the other end terminated inside the contact patch 10 of the inner side middle land portion 33. The lug grooves 52 are formed to be in a long form mainly extending in the tire width direction. A plurality of the lug grooves 52 are provided at an interval along the tire circumferential direction. The lug groove 52 has a sipe (not illustrated) along the longitudinal direction of the groove bottom and has a chamfered portion on the contact patch 10 side of the sipe, to be formed in the configuration described above. The chamfer portion may be on both sides of the sipe width of the sipe or only on one side of the sipe width. The sipe of the lug groove 52 has a sipe width in a range between 0.3 mm and 1.5 mm both inclusive, and a sipe depth from the contact patch 10 in a range between 3.3 mm and 4.5 mm both inclusive. The lug groove 51 has a depth of the chamfered portion in the sipe depth, being in a range between 1.0 mm and 3.0 mm both inclusive, and a chamfered width in a range between 1.5 mm and 4.5 mm both inclusive. The lug groove 51 only has the sipe closed when the contact patch 10 comes into contact with the road surface.

The lug groove 52 preferably satisfies a relationship 0.60≤L3/Wci≤0.70, where L3 represents a dimension of the lug groove 52 in the tire width direction and Wci represents the land portion width of the inner side middle land portion 33. The lug groove 52 satisfies 0.60≤L3/Wci to ensure a water removing effect to contribute to the improvement of the steering stability performance on wet road surfaces, and satisfies L3/Wci≤0.70 to ensure the rigidity of the inner side middle land portion 33 to contribute to steering stability performance on dry road surfaces.

The sipe 43 is provided extending toward the outer side in the tire width direction with one end in communication with the inner side center main groove 22 and with the other end terminated inside the contact patch 10 of the inner side middle land portion 33. A plurality of the sipes 43 are provided at an interval along the tire circumferential direction. The sipe 43 has a sipe width in a range between 0.6 mm and 1.8 mm both inclusive, and a sipe depth in a range between 3.0 mm and 7.0 mm both inclusive. The sipe 43 is closed when the contact patch 10 is in contact with the ground. The sipes 43 and the lug grooves 52 are disposed alternately in the tire circumferential direction. Compared with a configuration only having the lug grooves or the sipes arranged in the tire circumferential direction, this configuration ensures the water removing effect to contribute to the improvement of the steering stability performance on wet road surfaces, and ensures balanced rigidity of the inner side middle land portion 33 to contribute to the steering stability performance on dry road surfaces. In particular, with the lug grooves 52 disposed in an edge portion on the outer side in the tire width direction (the ground contact edge T side) where the contribution to the water removing effect is high in the inner side middle land portion 33 and with the sipes 43 disposed in an edge portion on the inner side in the tire width direction (the tire equatorial plane CL side) where contribution to the rigidity improvement is high in the inner side middle land portion 33, the balance between steering stability performance on wet road surfaces and steering stability performance on dry road surfaces can be effectively increased.

The sipe 43 preferably satisfies a relationship 0.20≤L4/Wci≤0.25, where L4 represents a dimension of the sipe 43 in the tire width direction and Wci represents the land portion width of the inner side middle land portion 33. The sipe 43 satisfies 0.20≤L4/Wci to ensure a water removing effect to contribute to the improvement of the steering stability performance on wet road surfaces, and satisfies L4/Wci≤0.25 to ensure the rigidity of the inner side middle land portion 33 to contribute to steering stability performance on dry road surfaces.

Note that the sipes 43 and the lug grooves 52 are disposed without overlapping with each other as viewed in the tire circumferential direction. Specifically, a dimension D2 in the tire width direction between the terminating end of the sipe 43 and the terminating end of the lug grooves 52 and the land portion width Wci of the inner side middle land portion 33 are preferably in a range satisfying 0.05≤D2/Wci≤0.20. This configuration ensures rigidity of the inner side middle land portion 33 compared with a configuration in which these elements overlap with each other in the tire circumferential direction, to contribute to improvement of the steering stability performance on dry road surfaces.

Additionally, the sipes 43 of the inner side middle land portion 33 and the sipes 41 of the center land portion 31 are inclined in the identical direction with respect to the tire circumferential direction. Additionally, the sipe 43 and the sipe 41 each extend along the extension line of the other, have one ends in communication with the inner side center main groove 22, and are provided opposite to each other with the inner side center main groove 22 provided in between. With this configuration, the sipes 43 and 41 ensure a water removing effect to contribute to improvement of the steering stability performance on wet road surfaces.

The outer side shoulder land portion 34 only has a lug groove 53 and a sipe 44 formed on the contact patch 10.

The lug grooves 53 extend from the outer side in the tire width direction toward the inner side in the tire width direction and intersect the ground contact edge T, and include an extending end terminated in the contact patch 10 of the outer side shoulder land portion 34 without communicating with the outer side shoulder main groove 23. A plurality of the lug grooves 53 are provided at an interval along the tire circumferential direction. The lug groove 53 has a groove width in a range between 1.5 mm and 4.5 mm both inclusive, and has a groove depth in a range between 55% and 80% of the groove depth of the outer side shoulder main groove 23.

The lug groove 53 preferably satisfies a relationship 0.50≤L5/Wso≤0.85, where L5 represents a dimension toward the inner side in tire width direction from the ground contact edge T and Wso represents the land portion width of the outer side shoulder land portion 34. The lug groove 53 satisfies 0.50≤L5/Wso to ensure a water removing effect to contribute to the improvement of the steering stability performance on wet road surfaces, and satisfies L5/Wso≤0.85 to ensure the rigidity of the outer side shoulder land portion 34 to contribute to steering stability performance on dry road surfaces. The land portion width Wso of the outer side shoulder land portion 34 is the dimension in the tire width direction between the edge portion of the outer side shoulder main groove 23 on the outer side in the tire width direction and the ground contact edge T on the vehicle outer side.

The sipe 44 extends toward the outer side in tire width direction to have one end in communication with the outer side shoulder main groove 23, and has the other end terminating in the contact patch 10 of the outer side shoulder land portion 34 so as not to cross the ground contact edge T. A plurality of the sipes 44 are provided at an interval along the tire circumferential direction. The sipe 44 has a sipe width in a range between 0.6 mm and 1.8 mm both inclusive, and a sipe depth in a range between 3.0 mm and 7.0 mm both inclusive. The sipe 44 is closed when the contact patch 10 is in contact with the ground. The sipes 44 and the lug grooves 53 are disposed alternately in the tire circumferential direction. Compared with a configuration only having the lug grooves or the sipes arranged in the tire circumferential direction, this configuration ensures the water removing effect to contribute to the improvement of the steering stability performance on wet road surfaces, and ensures balanced rigidity of the outer side shoulder land portion 34 to contribute to the steering stability performance on dry road surfaces.

The sipe 44 preferably satisfies a relationship 0.50≤L6/Wso≤0.85, where L6 represents a dimension of the sipe 44 in the tire width direction and Wso represents the land portion width of the outer side shoulder land portion 34. The sipe 44 satisfies 0.50≤L6/Wso to ensure a water removing effect to contribute to the improvement of the steering stability performance on wet road surfaces, and satisfies L6/Wso≤0.85 to ensure the rigidity of the outer side shoulder land portion 34 to contribute to steering stability performance on dry road surfaces.

Note that the sipes 44 and the lug grooves 53 are disposed to overlap with each other as viewed in the tire circumferential direction. Specifically, a dimension D3 in the tire width direction between the terminating end of the sipe 44 and the terminating end of the lug grooves 53 overlapping each other, and the land portion width Wso of the outer side shoulder land portion 34 are preferably in a range satisfying 0.50≤D3/Wso≤0.70. This configuration ensures a water removing effect to contribute to improvement of the steering stability performance on wet road surfaces, compared with a configuration in which these elements do not overlap with each other in the tire circumferential direction.

The inner side shoulder land portion 35 only has circumferential narrow groove 61, a lug groove 54, and a sipe 45 formed.

The circumferential narrow groove 61 is a narrow groove extending in the tire circumferential direction and extends over the entire tire circumference. The circumferential narrow groove 61 has a groove width in a range between 0.8 mm and 3.0 mm both inclusive, and a groove depth in a range between 0.8 mm and 3.0 mm both inclusive. The circumferential narrow groove 61 divides the inner side shoulder land portion 35 into an inner side land portion 351 on the inner side in the tire width direction that is on the inner side shoulder main groove 24 side and an outer side land portion 352 on the outer side in the tire width direction that is the ground contact edge T side.

A dimension D4 in the tire width direction from the edge portion of the circumferential narrow groove 61 on the outer side in the tire width direction to the ground contact edge T on the vehicle inner side, and a land portion width Wsi of the inner side shoulder land portion 35 preferably satisfy a relationship 0.55≤D4/Wsi≤0.85. This configuration has, in the inner side shoulder land portion 35, the circumferential narrow groove 61 having the position set in the tire width direction so that the water removing effect is optimized, and thus contributes to the improvement of the steering stability performance on wet road surfaces. Additionally, the circumferential narrow groove 61 sets the land portion widths of the inner side land portion 351 and the outer side land portion 352 in the inner side shoulder land portion 35, to optimize the rigidity of the inner side land portion 351 and the outer side land portion 352, to contribute to the improvement of the steering stability performance on dry road surfaces.

The lug grooves 54 extend from the outer side in the tire width direction toward the inner side in the tire width direction and intersect the ground contact edge T, and include an extending end terminated in the contact patch 10 of the inner side shoulder land portion 35 without communicating with the inner side shoulder main groove 24. The lug groove 54 communicates with the circumferential narrow groove 61, and has a terminating end in the contact patch 10 of the inner side land portion 351. A plurality of the lug grooves 54 are provided at an interval along the tire circumferential direction. The lug groove 54 has a groove width in a range between 1.5 mm and 4.5 mm both inclusive, and has a groove depth in a range between 55% and 80% of the groove depth of the inner side shoulder main groove 24.

The lug groove 54 preferably satisfies a relationship 0.60≤L7/Wsi≤0.85, where L7 represents a dimension toward the inner side in tire width direction from the ground contact edge T and Wsi represents the land portion width of the inner side shoulder land portion 35. The lug groove 54 satisfies 0.60≤L7/Wsi to ensure a water removing effect to contribute to the improvement of the steering stability performance on wet road surfaces, and satisfies L7/Wsi≤0.85 to ensure the rigidity of the inner side shoulder land portion 35, the rigidity of the inner side land portion 351 in particular, to contribute to steering stability performance on dry road surfaces. The land portion width Wsi of the inner side shoulder land portion 35 is the dimension in the tire width direction between the edge portion of the inner side shoulder main groove 24 on the inner side in the tire width direction and the ground contact edge T on the vehicle inner side.

The sipe 45 extends toward the outer side in tire width direction to have one end in communication with the inner side shoulder main groove 24, and has the other end terminating in the contact patch 10 of the inner side shoulder land portion 35 so as not to cross the ground contact edge T. The sipe 45 communicates with the circumferential narrow groove 61, and has a terminating end in the contact patch 10 of the outer side land portion 352. A plurality of the sipes 45 are provided at an interval along the tire circumferential direction. The sipe 45 has a sipe width in a range between 0.6 mm and 1.8 mm both inclusive, and a sipe depth in a range between 3.0 mm and 7.0 mm both inclusive. The sipe 45 is closed when the contact patch 10 is in contact with the ground. The sipes 45 and the lug grooves 53 are disposed alternately in the tire circumferential direction. Compared with a configuration only having the lug grooves or the sipes arranged in the tire circumferential direction, this configuration ensures the water removing effect to contribute to the improvement of the steering stability performance on wet road surfaces, and ensures balanced rigidity of the inner side shoulder land portion 35 to contribute to the steering stability performance on dry road surfaces.

The sipe 45 preferably satisfies a relationship 0.70≤L8/Wsi≤0.90, where L8 represents a dimension of the sipe 45 in the tire width direction and Wsi represents the land portion width of the inner side shoulder land portion 35. The sipe 45 satisfies 0.70≤L8/Wsi to ensure a water removing effect to contribute to the improvement of the steering stability performance on wet road surfaces, and satisfies L8/Wsi≤0.90 to ensure the rigidity of the inner side shoulder land portion 35, the rigidity of the outer side land portion 352 in particular, to contribute to steering stability performance on dry road surfaces.

Note that the sipes 45 and the lug grooves 54 are disposed to overlap with each other as viewed in the tire circumferential direction. This configuration ensures a water removing effect to contribute to improvement of the steering stability performance on wet road surfaces, compared with a configuration in which these elements do not overlap with each other in the tire circumferential direction.

The pneumatic tire 1 of the present embodiment described above includes: the outer side center main groove 21 that is a circumferential main groove 20 having a zigzag shape that extends in the tire circumferential direction in the contact patch 10 of the tread portion 2; and the center land portion 31 and the outer side middle land portion 32 which are land portions 30 defined and formed on both sides of the outer side center main groove 21 in the tire width direction, that is, bounded by the outer side center main groove 21. The respective contact patches 10 of the center land portion 31 and the outer side middle land portion 32 are formed to protrude toward the outer side in the tire radial direction from a reference profile.

In the present embodiment, the circumferential main groove having a zigzag shape is the outer side center main groove 21, but this should not be construed in a limiting sense. For example, the circumferential main groove 20 having a zigzag shape may be the inner side center main groove 22. In this case, the land portions 30 defined and formed on both sides of the inner side center main groove 22 in the tire width direction and bounded by the inner side center main groove 22 are the center land portion 31 and the inner side middle land portion 33. Furthermore, the circumferential main groove 20 having a zigzag shape may be the outer side shoulder main groove 23. In this case, the land portions 30 defined and formed on both sides of the outer side shoulder main groove 23 in the tire width direction and bounded by the outer side shoulder main groove 23 are the outer side middle land portion 32 and the outer side shoulder land portion 34. Furthermore, the circumferential main groove 20 having a zigzag shape may be the inner side shoulder main groove 24. In this case, the land portions 30 defined and formed on both sides of the inner side shoulder main groove 24 in the tire width direction and bounded by the inner side shoulder main groove 24 are the inner side middle land portion 33 and the inner side shoulder land portion 35.

Here, as illustrated in FIG. 3, the reference profile is an arc passing through three points including groove opening ends of the circumferential main groove 20 having a zigzag shape; and other circumferential main grooves 20 defining the land portions 30 on both sides of the circumferential main groove 20 in the tire width direction or the ground contact edge T.

Specifically, when the zigzag-shaped circumferential main groove 20 is the outer side center main groove 21, the contact patches 10 of the center land portion 31 and the outer side middle land portion 32 defined and formed on both sides of the outer side center main groove 21 in the tire width direction are formed to protrude toward the outer side in the tire radial direction. In this case, as illustrated in FIG. 3, in a meridian cross-section in a state where the pneumatic tire 1 is mounted on the specified rim and inflated to the specified internal pressure, and in an unloaded state (specified load=0), a reference profile PRcc of the center land portion 31 is an arc passing through three points including groove opening ends P1o and P2o of the outer side center main groove 21 that is the zigzag shaped circumferential main groove 20, and a groove opening end P1i of the inner side center main groove 22 that is another circumferential main groove 20 defining the center land portion 31 on the side of the center land portion 31. The contact patch 10 of the center land portion 31 is a gradual curve (or an arc) formed from each groove opening end P1o and P1i toward the center portion in the tire width direction to protrude toward the outer side in the tire radial direction, in the land portion width Wcc of the center land portion 31 that is a dimension in the tire width direction between the groove opening end P1o of the outer side center main groove 21 and the groove opening end P1i of the inner side center main groove 22. Thus, in other words, a protruding amount Hcc of the center land portion 31 is a protruding difference from the reference profile PRcc with respect to the groove opening ends P1o and P1i, which are end portions of the land portion width Wcc in the tire width direction. Furthermore, in the meridian cross-section in a state where the pneumatic tire 1 is mounted on the specified rim and inflated to the specified internal pressure, and in an unloaded state (specified load=0), a reference profile PRco of the outer side middle land portion 32 is an arc passing through three points including the groove opening ends P1o and P2o of the outer side center main groove 21 that is the zigzag shaped circumferential main groove 20, and a groove opening end P4o of the outer side shoulder main groove 23 that is another circumferential main groove 20 defining the outer side middle land portion 32 on the side of the outer side middle land portion 32. The contact patch 10 of the outer side middle land portion 32 is a gradual curve (or an arc) formed from each groove opening end P2o and P3o toward the center portion in the tire width direction to protrude toward the outer side in the tire radial direction, in the land portion width Wco of the outer side middle land portion 32 that is a dimension in the tire width direction between the groove opening end P2o of the outer side center main groove 21 and the groove opening end P3o of the outer side shoulder main groove 23. Thus, in other words, a protruding amount Hco of the outer side middle land portion 32 is a protruding difference from the reference profile PRco with respect to the groove opening ends P2o and P3o, which are end portions of the land portion width Wco in the tire width direction.

Furthermore, when the circumferential main groove 20 having a zigzag shape is the inner side center main groove 22, the contact patches 10 of the center land portion 31 and the inner side middle land portions 33 defined and formed on both sides of the inner side center main groove 22 in the tire width direction are formed to protrude toward the outer side in the tire radial direction. In this case, as illustrated in FIG. 3, in a meridian cross-section in a state where the pneumatic tire 1 is mounted on the specified rim and inflated to the specified internal pressure, and in an unloaded state (specified load=0), a reference profile PRcc of the center land portion 31 is an arc passing through three points including groove opening ends P1i and P2i of the inner side center main groove 22 that is the zigzag shaped circumferential main groove 20, and a groove opening end P1o of the outer side center main groove 21 that is another circumferential main groove 20 defining the center land portion 31 on the side of the center land portion 31. The contact patch 10 of the center land portion 31 is a gradual curve (or an arc) formed from each groove opening end P1o and P1i toward the center portion in the tire width direction to protrude toward the outer side in the tire radial direction, in the land portion width Wcc of the center land portion 31 that is a dimension in the tire width direction between the groove opening end P1o of the outer side center main groove 21 and the groove opening end P1i of the inner side center main groove 22. Thus, in other words, a protruding amount Hcc of the center land portion 31 is a protruding difference from the reference profile PRcc with respect to the groove opening ends P1o and P1i, which are end portions of the land portion width Wcc in the tire width direction. Furthermore, in the meridian cross-section in a state where the pneumatic tire 1 is mounted on the specified rim and inflated to the specified internal pressure, and in an unloaded state (specified load=0), a reference profile PRci of the inner side middle land portion 33 is an arc passing through three points including the groove opening ends P1i and P2i of the inner side center main groove 22 that is the zigzag shaped circumferential main groove 20, and a groove opening end P4i of the inner side shoulder main groove 24 that is another circumferential main groove 20 defining the inner side middle land portion 33 on the side of the inner side middle land portion 33. The contact patch 10 of the inner side middle land portion 33 is a gradual curve (or an arc) formed from each groove opening end P2i and P3i toward the center portion in the tire width direction to protrude toward the outer side in the tire radial direction, in the land portion width Wci of the inner side middle land portion 33 that is a dimension in the tire width direction between the groove opening end P2i of the inner side center main groove 22 and the groove opening end P3i of the inner side shoulder main groove 24. Thus, in other words, a protruding amount Hci of the inner side middle land portion 33 is a protruding difference from the reference profile PRci with respect to the groove opening ends P2i and P3i, which are end portions of the land portion width Wci in the tire width direction.

Furthermore, when the circumferential main groove 20 having a zigzag shape is the outer side shoulder main groove 23, the contact patches 10 of the outer side middle land portion 32 and the outer side shoulder land portion 34 defined and formed on both sides of the outer side shoulder main groove 23 in the tire width direction are formed to protrude toward the outer side in the tire radial direction. In this case, as illustrated in FIG. 3, in the meridian cross-section in a state where the pneumatic tire 1 is mounted on the specified rim and inflated to the specified internal pressure, and in an unloaded state (specified load=0), a reference profile PRco of the outer side middle land portion 32 is an arc passing through three points including the groove opening ends P3o and P4o of the outer side shoulder main groove 23 that is the zigzag shaped circumferential main groove 20, and a groove opening end P2o of the outer side center main groove 21 that is another circumferential main groove 20 defining the outer side middle land portion 32 on the side of the outer side middle land portion 32. The contact patch 10 of the outer side middle land portion 32 is a gradual curve (or an arc) formed from each groove opening end P2o and P3o toward the center portion in the tire width direction to protrude toward the outer side in the tire radial direction, in the land portion width Wco of the outer side middle land portion 32 that is a dimension in the tire width direction between the groove opening end P2o of the outer side center main groove 21 and the groove opening end P3o of the outer side shoulder main groove 23. Thus, in other words, a protruding amount Hco of the outer side middle land portion 32 is a protruding difference from the reference profile PRco with respect to the groove opening ends P2o and P3o, which are end portions of the land portion width Wco in the tire width direction. Furthermore, in the meridian cross-section in a state where the pneumatic tire 1 is mounted on the specified rim and inflated to the specified internal pressure, and in an unloaded state (specified load=0), a reference profile PRso of the outer side shoulder land portion 34 is an arc passing through three points including the groove opening ends P3o and P4o of the outer side shoulder main groove 23 that is the zigzag shaped circumferential main groove 20, and the ground contact edge T on the vehicle outer side. The contact patch 10 of the outer side shoulder land portion 34 is a gradual curve (or an arc) formed from the groove opening end P4o and the ground contact edge T on the vehicle outer side toward the center portion in the tire width direction to protrude toward the outer side in the tire radial direction, in the land portion width Wso of the outer side shoulder land portion 34 that is a dimension in the tire width direction between the groove opening end P4o of the outer side shoulder main groove 23 and the ground contact edge T on the vehicle outer side. Thus, in other words, a protruding amount Hso of the outer side shoulder land portion 34 is a protruding difference from the reference profile PRso with respect to the groove opening end P4o and the ground contact edge T on the vehicle outer side, which are end portions of the land portion width Wso in the tire width direction.

Furthermore, when the circumferential main groove 20 having a zigzag shape is the inner side shoulder main groove 24, the contact patches 10 of the inner side middle land portion 33 and the inner side shoulder land portion 35 defined and formed on both sides of the inner side shoulder main groove 24 in the tire width direction are formed to protrude toward the outer side in the tire radial direction. In this case, as illustrated in FIG. 3, in the meridian cross-section in a state where the pneumatic tire 1 is mounted on the specified rim and inflated to the specified internal pressure, and in an unloaded state (specified load=0), a reference profile PRci of the inner side middle land portion 33 is an arc passing through three points including the groove opening ends P3i and P4i of the inner side shoulder main groove 24 that is the zigzag shaped circumferential main groove 20, and a groove opening end P2i of the inner side center main groove 22 that is another circumferential main groove 20 defining the inner side middle land portion 33 on the side of the inner side middle land portion 33. The contact patch 10 of the inner side middle land portion 33 is a gradual curve (or an arc) formed from each groove opening end P2i and P3i toward the center portion in the tire width direction to protrude toward the outer side in the tire radial direction, in the land portion width Wci of the inner side middle land portion 33 that is a dimension in the tire width direction between the groove opening end P2i of the inner side center main groove 24 on the outer side in the tire width direction and the groove opening end P3i of the inner side shoulder main groove 22. Thus, in other words, a protruding amount Hci of the inner side middle land portion 33 is a protruding difference from the reference profile PRci with respect to the groove opening ends P2i and P3i, which are end portions of the land portion width Wci in the tire width direction. Furthermore, in the meridian cross-section in a state where the pneumatic tire 1 is mounted on the specified rim and inflated to the specified internal pressure, and in an unloaded state (specified load=0), a reference profile PRsi of the inner side shoulder land portion 35 is an arc passing through three points including the groove opening ends P3i and P4i of the inner side shoulder main groove 24 that is the zigzag shaped circumferential main groove 20, and the ground contact edge T on the vehicle inner side. The contact patch 10 of the inner side shoulder land portion 35 is a gradual curve (or an arc) formed from the groove opening end P4i and the ground contact edge T on the vehicle inner side toward the center portion in the tire width direction to protrude toward the outer side in the tire radial direction, in the land portion width Wsi of the inner side shoulder land portion 35 that is a dimension in the tire width direction between the groove opening end P4i of the inner side shoulder main groove 24 on the inner side in the tire width direction and the ground contact edge T on the vehicle inner side. Thus, in other words, a protruding amount Hsi of the inner side shoulder land portion 35 is a protruding difference from the reference profile PRsi with respect to the groove opening end P4i and the ground contact edge T on the vehicle inner side, which are end portions of the land portion width Wsi in the tire width direction.

Thus, the pneumatic tire 1 according to the present embodiment includes the circumferential main groove 20 having a zigzag shape extending in the tire circumferential direction in the contact patch 10 of the tread portion 2, and the land portions 30 defined and formed on both sides of the circumferential main groove 20 in the tire width direction, and bounded by the circumferential main groove 20, and the contact patch 10 of each of the land portions 30 protrudes toward the outer side in the tire radial direction from the reference profile.

In this pneumatic tire 1, the contact patches 10 of the land portions 30 provided on both sides in the tire width direction and bounded by the circumferential main groove 20 having a zigzag shape are formed to protrude toward the outer side in the tire radial direction from the reference profile, thus, the contact patch length in the center portion of each land portion 30 in the tire width direction can be ensured, whereby the contact patch pressure of each land portion 30 can be ensured. Thus, non-uniformity of the contact patch pressure around the groove edge of the circumferential main groove 20 having a zigzag shape is suppressed, whereby a ground contact effect is improved so that the steering stability performance on dry road surfaces can be improved. Furthermore, with non-uniformity of the contact patch pressure around the groove edge of the circumferential main groove 20 having a zigzag shape suppressed, a water removing effect for the circumferential main groove 20 is improved, whereby the steering stability performance on wet road surfaces can be improved. As a result, the steering stability performance on dry road surfaces and the steering stability performance on wet road surfaces can be improved.

Furthermore, in the pneumatic tire 1 according to the present embodiment, protruding amounts Ha and Hb of the land portions 30 on both sides in the tire width direction and bounded by the circumferential main groove 20 having a zigzag shape are in ranges of 0.2 mm≤Ha≤0.4 mm and 0.2 mm≤Hb≤0.4 mm.

The protruding amounts Ha and Hb of the land portions 30 correspond to the protruding amount Hcc of the center land portion 31, the protruding amount Hco of the outer side middle land portion 32, the protruding amount Hci of the inner side middle land portion 33, the protruding amount Hso of the outer side shoulder land portion 34, and the protruding amount Hsi of the inner side shoulder land portion 35 described above. Thus, the respective protruding amounts Hcc and Hco of the center land portions 31 and the outer side middle land portion 32 on both sides of the outer side center main groove 21 that is the circumferential main groove 20 having a zigzag shape in the tire width direction are preferably in ranges 0.2 mm≤Hcc≤0.4 mm and 0.2 mm≤Hco≤0.4 mm. Furthermore, the respective protruding amounts Hcc and Hci of the center land portions 31 and the inner side middle land portion 33 on both sides of the inner side center main groove 22 that is the circumferential main groove 20 having a zigzag shape in the tire width direction are preferably in ranges 0.2 mm≤Hcc≤0.4 mm and 0.2 mm≤Hci≤0.4 mm. Furthermore, the respective protruding amounts Hco and Hso of the outer side middle land portion 32 and the outer side shoulder land portion 34 on both sides of the outer side shoulder main groove 23 that is the circumferential main groove 20 having a zigzag shape in the tire width direction are preferably in ranges 0.2 mm≤Hco≤0.4 mm and 0.2 mm≤Hso≤0.4 mm. Furthermore, the respective protruding amounts Hci and Hsi of the inner side middle land portion 33 and the inner side shoulder land portion 35 on both sides of the inner side shoulder main groove 24 that is the circumferential main groove 20 having a zigzag shape in the tire width direction are preferably in ranges 0.2 mm≤Hci≤0.4 mm and 0.2 mm≤Hsi≤0.4 mm.

In this pneumatic tire 1, the protruding amounts Ha and Hb of the land portions 30 on both sides in the tire width direction bounded by the circumferential main groove 20 having a zigzag shape are set to be equal to or larger than 0.2 mm so that the contact patch pressure around the center position in the tire width direction can be closer to the contact patch pressure at positions on the outer side in the tire width direction, and are set to be equal to or smaller than 0.4 mm so that the protruding amounts Ha and Hb are suppressed at the positions on the both outer sides in the tire width direction, whereby the contact patch pressure at the positions on both outer sides in the tire width direction can be prevented from being excessively low. As a result, gripping force to a road surface, whereby the steering stability performance on dry road surfaces and the steering stability performance on wet road surfaces can be improved.

Furthermore, in the pneumatic tire 1 according to the present embodiment, the protruding amounts Ha and Hb of the land portions 30 on both sides in the tire width direction with and bounded by the circumferential main groove 20 having a zigzag shape preferably satisfies a relationship 0.9≤Ha/Hb≤1.1.

With this pneumatic tire 1, excessive variation in the contact patch pressure in each of the land portions 30 on both sides in the tire width direction bounded by the circumferential main groove 20 having a zigzag shape can be suppressed, and thus excellent footprint properties of the land portions 30 can be achieved, whereby gripping force to a road surface can be improved. As a result, the steering stability performance on dry road surfaces and the steering stability performance on wet road surfaces can be improved.

Furthermore, in the pneumatic tire 1 according to the present embodiment, as illustrated in FIG. 2, the number of bend portions of the circumferential main groove 20 having a zigzag shape (the outer side center main groove 21 in FIG. 2) in the tire circumferential direction to define the zigzag shape is limited. Specifically, when the number of sections of the outer side shoulder land portion 34 and the inner side shoulder land portion 35 defined in the tire circumferential direction by the lug grooves 53 and 54 of the shoulder land portions (the outer side shoulder land portion 34 and the inner side shoulder land portion 35 in the present embodiment) defined and formed on the outermost sides in the tire width direction is n, the number of bent portions is n. Specifically, as illustrated in FIG. 2, the number of bent portions of the circumferential main groove 20 having a zigzag shape in the tire circumferential direction forming the zigzag shape is identical to the number n of the sections of the outer side shoulder land portion 34 and the inner side shoulder land portion 35 defined in the tire circumferential direction by the lug grooves 53 and 54.

Furthermore, in the pneumatic tire 1 according to the present embodiment, as illustrated in FIG. 6, the number of bend portions of the circumferential main groove 20 having a zigzag shape (the outer side center main groove 21 in FIG. 6) in the tire circumferential direction to define the zigzag shape is limited. Specifically, when the number of sections of the outer side shoulder land portion 34 and the inner side shoulder land portion 35 defined in the tire circumferential direction by the lug grooves 53 and 55 and the lug grooves 54 and 56 of the shoulder land portions (the outer side shoulder land portion 34 and the inner side shoulder land portion 35 in the present embodiment) defined and formed on the outermost sides in the tire width direction is n, the number of bent portions is n/2. Specifically, as illustrated in FIG. 6, the number of bent portions of the circumferential main groove 20 having a zigzag shape in the tire circumferential direction forming the zigzag shape is ½ of the number n of the sections of the outer side shoulder land portion 34 and the inner side shoulder land portion 35 defined in the tire circumferential direction by the lug grooves 53 and 54.

Here, as illustrated in FIG. 6, the lug groove 55 of the outer side shoulder land portion 34 is disposed between the lug grooves 53 and extends beyond the ground contact edge T to be in communication with the sipe 44. The lug groove 55 has a groove width in a range between 1.5 mm and 4.5 mm both inclusive, and has a groove depth in a range between 55% and 80% of the groove depth of the outer side shoulder main groove 23. Furthermore, the lug groove 56 of the inner side shoulder land portion 35 is disposed between the lug grooves 54 and extends beyond the ground contact edge T to be in communication with the sipe 45. The lug groove 56 has a groove width in a range between 1.5 mm and 4.5 mm both inclusive, and has a groove depth in a range between 55% and 80% of the groove depth of the inner side shoulder main groove 24.

With this pneumatic tire 1, for the sake of improvement of the steering stability performance on wet road surfaces, to improve the water removing effect of the outer side shoulder land portion 34 and the inner side shoulder land portion 35 particularly during turning, as illustrated in FIG. 6, the outer side shoulder land portion 34 is provided with the lug grooves 53 and 55 and the inner side shoulder land portion 35 is provided with the lug grooves 54 and 56. In this case, with the lug grooves 53 and 55 and the lug grooves 54 and 56 provided, the rigidity of the outer side shoulder land portion 34 and the inner side shoulder land portion 35 might be low. In view of this the number of bent portions of the circumferential main groove 20 having a zigzag shape (the outer side center main groove 21 in FIG. 6) in the tire circumferential direction is n/2, where n is the number of sections of the outer side shoulder land portion 34 and the inner side shoulder land portion 35 defined in the tire circumferential direction. Thus, the rigidity around the groove edge of the circumferential main groove 20 having a zigzag shape is ensured, and degradation of the steering stability performance on dry road surfaces is suppressed. On the other hand, to improve the rigidity the outer side shoulder land portion 34 and the inner side shoulder land portion 35 for the sake of improvement of the steering stability performance on dry road surfaces, as illustrated in FIG. 2, the outer side shoulder land portion 34 is only provided with the lug grooves 53 and the inner side shoulder land portion 35 is only provided with the lug grooves 54. In this case, because only the lug grooves 53 and the lug grooves 54 are provided, the water removing effect of the outer side shoulder land portion 34 and the inner side shoulder land portion 35 might be low. In view of this the number of bent portions of the circumferential main groove 20 having a zigzag shape (the outer side center main groove 21 in FIG. 6) in the tire circumferential direction is n, where n is the number of sections of the outer side shoulder land portion 34 and the inner side shoulder land portion 35 defined in the tire circumferential direction. Thus, the water removing effect around the groove edge of the circumferential main groove 20 having a zigzag shape is ensured, and degradation of the steering stability performance on wet road surfaces is suppressed. As a result, the steering stability performance on dry road surfaces and the steering stability performance on wet road surfaces can be improved.

Furthermore, as illustrated in FIGS. 2, 3, and 6, in the pneumatic tire 1 according to the present embodiment, the circumferential main groove 20 having a zigzag shape (the outer side center main groove 21 in the present embodiment) is preferably disposed in a range WTC that is 30% of the ground contact width centered on the tire equatorial plane Cl.

According to this pneumatic tire 1, in the range WTC that is 30% of the ground contact width centered on the tire equatorial plane Cl, the contact patch length becomes the longest. Thus, with the circumferential main groove 20 having a zigzag shape with a high water removing effect provided in this portion, drainage performance is improved. As a result, the steering stability performance on wet road surfaces can be improved.

Furthermore, in the pneumatic tire 1 according to the present embodiment, the circumferential main groove 20 having a zigzag shape (the outer side center main groove 21 in the present embodiment) preferably includes a plurality of the triangular chamfered portions 25, with which the zigzag shape opens to the contact patch 10 in the groove opening end, formed side by side in the tire circumferential direction as illustrated in FIGS. 4 and 5.

With this pneumatic tire 1, the zigzag shape is form by the chamfered portions 25 at the groove opening ends so that the rigidity on the groove bottom side of the circumferential main groove 20 can be ensured. As a result, the steering stability performance on dry road surfaces can be improved, while having the steering stability performance on wet road surfaces improved by the zigzag shape.

Furthermore, in the pneumatic tire 1 according to the present embodiment, as illustrated in FIGS. 4 and 5, the circumferential main groove 20 having a zigzag shape (the outer side center main groove 21 in the present embodiment) preferably has the chamfered portion 25 with a tire width direction dimension (the length direction) being in a range of 1.0 mm≤Wg≤3.5 mm, and with a tire radial direction dimension Lg (depth direction) being in a range of 1.0 mm≤Lg≤3.0 mm.

With this pneumatic tire 1, the rigidity on the groove bottom side of the circumferential main groove 20 can be ensured, while achieving the water removing effect with the chamfered portions 25. As a result, the steering stability performance on dry road surfaces can be improved, while having the steering stability performance on wet road surfaces improved by the zigzag shape.

Furthermore, in the pneumatic tire 1 according to the present embodiment, the land portions 30 on both sides in the tire width direction that are bounded by the circumferential main groove 20 having a zigzag shape (the outer side center main groove 21 in the present embodiment) respectively have land portion widths Wa and Wb satisfying a relationship 0.8≤Wa/Wb≤1.5.

The land portion widths Wa and Wb of the land portions 30 correspond to the land portion width Wcc of the center land portion 31, the land portion width Wco of the outer side middle land portion 32, the land portion width Wci of the inner side middle land portion 33, the land portion width Wso of the outer side shoulder land portion 34, and the land portion width Wsi of the inner side shoulder land portion 35 described above. Thus, the respective land portion widths Wcc and Wco of the center land portion 31 and the outer side middle land portion 32 on both sides of the outer side center main groove 21 that is the circumferential main groove 20 having a zigzag shape in the tire width direction preferably satisfy a relationship 0.8≤Wcc/Wco≤1.5. Furthermore, the respective land portion widths Wcc and Wci of the center land portion 31 and the inner side middle land portion 33 on both sides of the inner side center main groove 22 that is the circumferential main groove 20 having a zigzag shape in the tire width direction preferably satisfy a relationship 0.8≤Wcc/Wci≤1.5. Furthermore, the respective land portion widths Wco and Wso of the outer side middle land portion 32 and the outer side shoulder land portion 34 on both sides of the outer side shoulder main groove 23 that is the circumferential main groove 20 having a zigzag shape in the tire width direction preferably satisfy a relationship 0.8≤Wco/Wso≤1.5. Furthermore, the respective land portion widths Wci and Wsi of the inner side middle land portion 33 and the inner side shoulder land portion 35 on both sides of the inner side shoulder main groove 24 that is the circumferential main groove 20 having a zigzag shape in the tire width direction preferably satisfy a relationship 0.8≤Wci/Wsi≤1.5.

With this pneumatic tire 1, excessive variation in the contact patch pressure in each of the land portions 30 on both sides in the tire width direction bounded by the circumferential main groove 20 having a zigzag shape can be suppressed, and thus excellent footprint properties of the land portions 30 can be achieved, whereby gripping force to a road surface can be improved. As a result, the steering stability performance on dry road surfaces and the steering stability performance on wet road surfaces can be improved.

### Examples

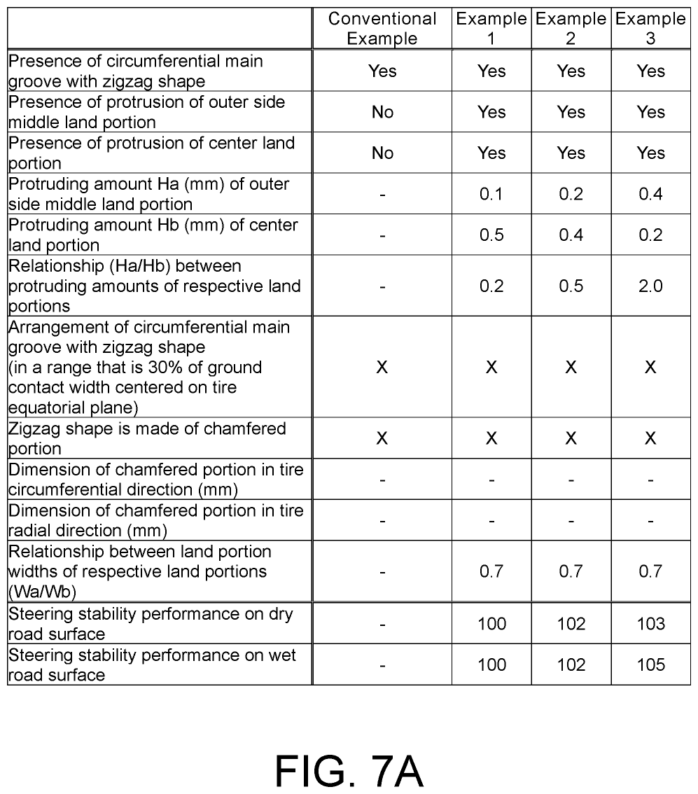

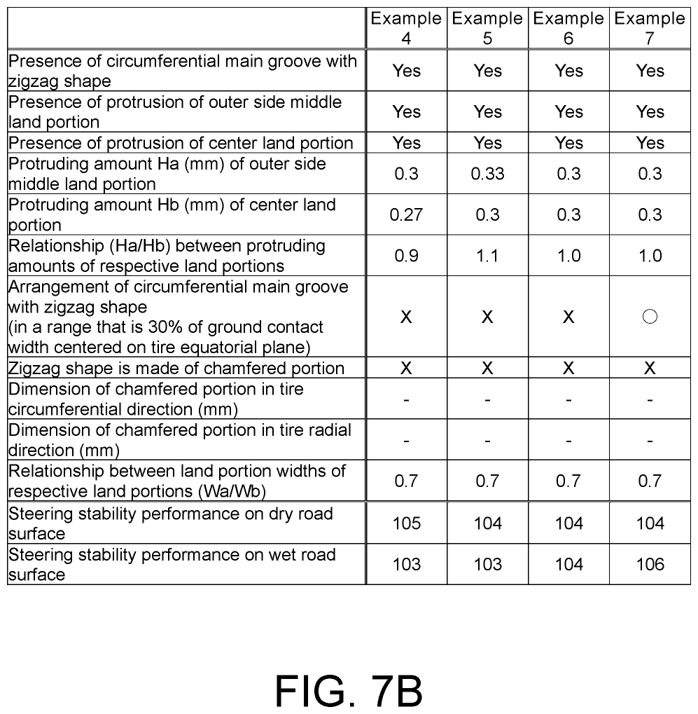

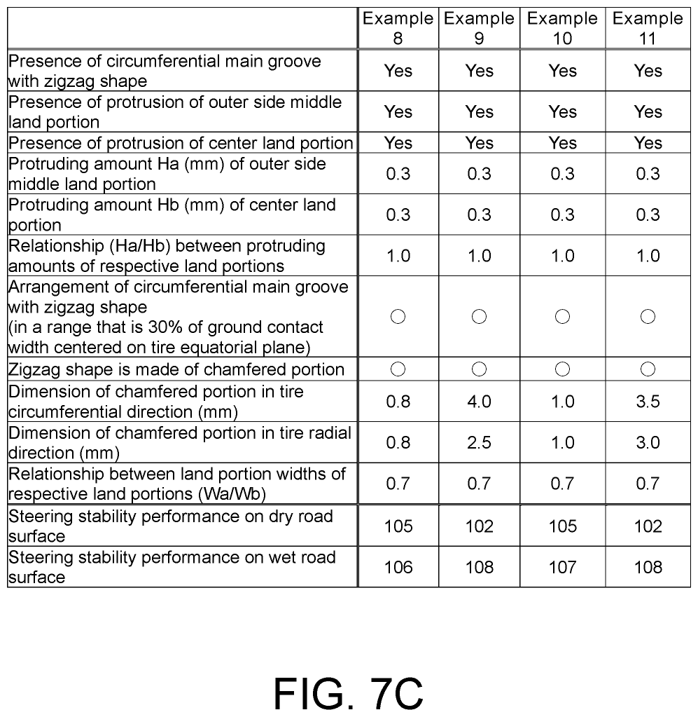

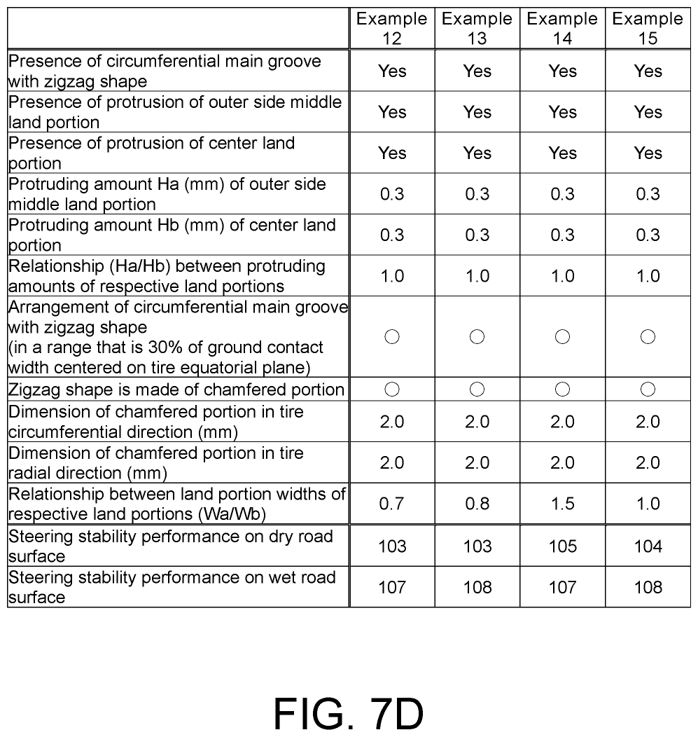

In the examples, performance tests for steering stability performance (also referred to as dry performance) on dry road surfaces and steering stability performance (also referred to as wet performance) on wet road surfaces were performed on a plurality of types of pneumatic tires of different conditions (see FIGS. 7A-7D).

The performance evaluation test was performed with a pneumatic tire, which was a test tire having a nominal tire designated by JATMA, having a size of 225/50R17 98 W, assembled on a regular rim having a rim size of 17×75J, inflated to an internal pressure of 230 kPa, and mounted on front and rear wheels of a sedan type test vehicle.

The steering stability performance on dry road surfaces is evaluated with the test vehicle driven on a dry road test course and with the dedicated test driver performing sensory evaluations for drive control performance, lane changing performance, and cornering performance. The evaluation is expressed as index values with the value of the Conventional Example being defined as the reference (100). In this evaluation, larger index values indicate superior steering stability performance on dry road surfaces.

The steering stability performance on wet road surfaces is evaluated with the test vehicle driven on a wet road test course and with the dedicated test driver performing sensory evaluations for drive control performance, lane changing performance, and cornering performance. The evaluation is expressed as index values with the value of the Conventional Example being defined as the reference (100). In this evaluation, larger index values indicate superior steering stability performance on wet road surfaces.

The pneumatic tires according to Conventional Example and Examples 1 to 15 in FIGS. 7A-7D have five land portions defined and formed in the tire width direction by four circumferential main grooves (the outer side center main groove, the inner side center main groove, the outer side shoulder main groove, and the inner side shoulder main groove) extending in the tire circumferential direction in the contact patch of the tread portion as illustrated in FIGS. 2 and 6, and thus include the center land portion on the tire equatorial plane, the outer side middle land portion on the vehicle outer side of the center land portion, the outer side shoulder land portion on the vehicle outer side of the outer side middle land portion, the inner side middle land portion on the vehicle inner side of the center land portion, and the inner side shoulder land portion on the vehicle inner side of the inner side middle land portion. Furthermore, the pneumatic tires according to Conventional Example and Examples 1 to 15 have the inner side center main groove formed in a zigzag shape.

The pneumatic tire according to Conventional Example has the contact patches of the land portions on both sides of the tire width direction bounded by the circumferential main groove having a zigzag shape are on the reference profile. On the other hand, the pneumatic tires according to Examples 1 to 15 have the contact patch of each of the land portions on both sides in the tire width direction bounded by the circumferential main groove having a zigzag shape protruding toward the outer side in the tire radial direction from the reference profile.

As can be seen from the test results in FIGS. 7A-7D, the pneumatic tires according to Examples 1 to 15 have improved steering stability performance on dry and wet road surfaces.

1. A pneumatic tire, comprising:
a circumferential main groove having a zigzag shape and extending in a tire circumferential direction in a contact patch of a tread portion; and
land portions defined and formed on both sides in a tire width direction of the circumferential main groove, with the circumferential main groove as a boundary,
a contact patch of each of the land portions being formed protruding from a reference profile toward an outer side in a tire radial direction.

2. The pneumatic tire according to claim 1, wherein protruding amounts Ha and Hb of the respective land portions are in ranges of 0.2 mm≤Ha≤0.4 mm and 0.2 mm≤Hb≤0.4 mm.

3. The pneumatic tire according to claim 1, wherein the protruding amounts Ha and Hb of the respective land portions satisfy a relationship 0.9≤Ha/Hb≤1.1.

4. The pneumatic tire according to claim 1, comprising:
shoulder land portions defined and formed on outer most sides in the tire width direction in the contact patch of the tread portion; and
a plurality of lug grooves that are disposed side by side in the tire circumferential direction and extend intersecting the tire circumferential direction in the contact patch of the shoulder land portions, the plurality of lug grooves defining a plurality of sections of the shoulder land portions in the tire circumferential direction,
a number of bent portions in the tire circumferential direction forming the zigzag shape of the circumferential main groove being n or n/2, where n represents a number of sections of the shoulder land portions defined by the lug grooves in the tire circumferential direction.

5. The pneumatic tire according to claim 1, wherein the circumferential main groove is disposed in a range that is 30% of a ground contact width centered on the tire equatorial plane.

6. The pneumatic tire according to claim 1, wherein the circumferential main groove comprises a plurality of triangular chamfered portions, with which the zigzag shape opens to the contact patch in a groove opening end, formed side by side in the tire circumferential direction.

7. The pneumatic tire according to claim 6, wherein the chamfered portions of the circumferential main groove have a tire width direction dimension Wg in a range of 1.0 mm≤Wg≤3.5 mm, and have a tire radial direction dimension Lg in a range of 1.0 mm≤Lg≤3.0 mm.

8. The pneumatic tire according to claim 1, wherein land portion widths Wa and Wb of the respective land portions on both sides in the tire width direction bounded by the circumferential main groove satisfy a relationship 0.8≤Wa/Wb≤1.5.

9. The pneumatic tire according to claim 2, wherein the protruding amounts Ha and Hb of the respective land portions satisfy a relationship 0.9≤Ha/Hb≤1.1.

10. The pneumatic tire according to claim 9, comprising:
shoulder land portions defined and formed on outer most sides in the tire width direction in the contact patch of the tread portion; and
a plurality of lug grooves that are disposed side by side in the tire circumferential direction and extend intersecting the tire circumferential direction in the contact patch of the shoulder land portions, the plurality of lug grooves defining a plurality of sections of the shoulder land portions in the tire circumferential direction,
a number of bent portions in the tire circumferential direction forming the zigzag shape of the circumferential main groove being n or n/2, where n represents a number of sections of the shoulder land portions defined by the lug grooves in the tire circumferential direction.

11. The pneumatic tire according to claim 10, wherein the circumferential main groove is disposed in a range that is 30% of a ground contact width centered on the tire equatorial plane.

12. The pneumatic tire according to claim 11, wherein the circumferential main groove comprises a plurality of triangular chamfered portions, with which the zigzag shape opens to the contact patch in a groove opening end, formed side by side in the tire circumferential direction.

13. The pneumatic tire according to claim 12, wherein the chamfered portions of the circumferential main groove have a tire width direction dimension Wg in a range of 1.0 mm≤Wg≤3.5 mm, and have a tire radial direction dimension Lg in a range of 1.0 mm≤Lg≤3.0 mm.

14. The pneumatic tire according to claim 13, wherein land portion widths Wa and Wb of the respective land portions on both sides in the tire width direction bounded by the circumferential main groove satisfy a relationship 0.8≤Wa/Wb≤1.5.
